(19) United States
(12) Patent Application Publication
(10) Pub. No.: US 2023/0112212 A1
(43) Pub. Date: Apr. 13, 2023

(54) ADJUSTABLE MAGNIFIER FOR VIRTUAL DESKTOP

(71) Applicant: Citrix Systems, Inc., Fort Lauderdale, FL (US)

(72) Inventors: Shihao Qian, Nanjing (CN); Bo Zang, Nanjing (CN); Yu Xin, Nanjing (CN); Kai Lu, Nanjing (CN)

(21) Appl. No.: 17/504,971

(22) Filed: Oct. 19, 2021

Related U.S. Application Data
(63) Continuation of application No. PCT/CN2021/123179, filed on Oct. 12, 2021.

(51) Int. Cl. G06F 3/0481; G06F 3/0346; G06F 3/0484

(52) U.S. Cl. CPC G06F 3/0481; G06F 3/0346; G06F 3/04845; G06F 2203/04805

(57) ABSTRACT

Aspects include a computing device, method and computer readable medium for controlling a magnifier in a virtual desktop session. A disclosed computing device includes: a memory storing instructions for controlling a magnifier in a virtual desktop session; and a processor coupled to the memory and configured to execute the instructions to perform processes including: initiating the magnifier in the virtual desktop session to magnify a portion of content displayed on a client device; and in response to detecting a change in at least one of an orientation of the client device or a distance between the client device and a user: adjusting a magnification level of the magnifier on the portion of the content or shifting the magnifier to magnify a distinct portion of the content displayed on the client device.

### BACKGROUND OF THE DISCLOSURE

Virtual desktops and/or virtual applications are increasing in popularity and usage, particularly as a greater percentage of the workforce conducts business from decentralized office facilities. However, many users engage these virtual desktop sessions and/or virtual application sessions using smaller-scale devices with displays (e.g., screens) that are less suitable for reviewing, editing, collaborating, etc., as compared with desktop computing devices such as personal computers with or without external monitors.

### BRIEF DESCRIPTION OF THE DISCLOSURE

Aspects of this disclosure include a computing device, method and computer readable medium for controlling a magnifier in a virtual desktop session. A disclosed approach includes initiating the magnifier in the virtual desktop session to magnify a portion of content displayed on a client device. In response to detecting a change in at least one of an orientation of the client device or a distance between the client device and a user, the approach further includes adjusting a magnification level of the magnifier on the portion of the content or shifting the magnifier to magnify a distinct portion of the content displayed on the client device.

A first aspect of the disclosure provides a computing device that includes a memory storing instructions for controlling a magnifier in a virtual desktop session; and a processor coupled to the memory and configured to execute the instructions. The processor performs processes including initiating the magnifier in the virtual desktop session to magnify a portion of content displayed on a client device. In response to detecting a change in at least one of an orientation of the client device or a distance between the client device and a user: the processor adjusts a magnification level of the magnifier on the portion of the content or shifting the magnifier to magnify a distinct portion of the content displayed on the client device.

A second aspect of the disclosure provides a method of controlling a magnifier in a virtual desktop session. The method can include initiating the magnifier in the virtual desktop session to magnify a portion of content displayed on a client device. The method can further include, in response to detecting a change in at least one of an orientation of the client device or a distance between the client device and a user: adjusting a magnification level of the magnifier on the portion of the content, or shifting the magnifier to magnify a distinct portion of the content displayed on the client device.

A third aspect of the disclosure provides a computer readable medium having program code, which when executed by a computing device, causes the computing device to control a magnifier in a virtual desktop session by initiating the magnifier in the virtual desktop session to magnify a portion of content displayed on a client device. In response to detecting a change in at least one of an orientation of the client device or a distance between the client device and a user, the computing device adjusts a magnification level of the magnifier on the portion of the content, or shifts the magnifier to magnify a distinct portion of the content displayed on the client device.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative workspace environment configured to provide magnification controls, in accordance with an illustrative embodiment.

FIG. 2 is a flow diagram illustrating processes in a method performed in accordance with an illustrative embodiment.

FIG. 3 depicts a view of a client workspace, in accordance with an illustrative embodiment.

FIG. 4 depicts a view of the client workspace in FIG. 3, illustrating shifting of a magnifier, in accordance with an illustrative embodiment.

FIG. 5 is a graphical depiction illustrating a 2-tuple calculation in shifting a magnifier, in accordance with an illustrative embodiment.

FIG. 6 depicts a view of a client workspace, in accordance with an illustrative embodiment.

FIG. 7 depicts a view of the client workspace in FIG. 6, illustrating modifying of a magnifier level, in accordance with an illustrative embodiment.

FIG. 8 depicts a network infrastructure, in accordance with an illustrative embodiment.

FIG. 9 depicts a computing system, in accordance with an illustrative embodiment.

FIG. 10A is a block diagram of an example system in which resource management services may manage and streamline access by clients to resource feeds (via one or more gateway services) and/or software-as-a-service (SaaS) applications.

FIG. 10B is a block diagram showing an example implementation of the system shown in FIG. 10A in which various resource management services as well as a gateway service are located within a cloud computing environment.

FIG. 10C is a block diagram similar to that shown in FIG. 10B but in which the available resources are represented by a single box labeled “systems of record,” and further in which several different services are included among the resource management services.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for controlling a magnifier in a virtual desktop session. In conventional practice, certain virtual desktop sessions include a magnifier function that enables a user to magnify a portion of the desktop session displayed on their device's screen. These conventional magnifiers require user interaction to adjust location and/or magnification level, making them unwieldy, particularly when deployed on handheld (client) devices. To address these and other issues, various disclosed implementations control a magnifier in a virtual desktop session based on detected change(s) in the orientation of the client device and/or a distance between the client device and the user.

In particular implementations, approaches include, in response to detecting a change in at least one of an orientation of the client device or a distance between the client device and a user, adjusting a magnification level of the magnifier on a portion of the content or shifting the magnifier to magnify a distinct portion of the content displayed on the client device. In particular cases, the change in orientation is detected based on data from an orientation sensor onboard the client device. In certain cases, the change in distance between the client device and the user is detected with an optical sensor onboard the client device or onboard a connected device proximate to the user. The various disclosed approaches enable a user to effectively interact with a virtual workspace environment using a device that may have a relatively small display size.

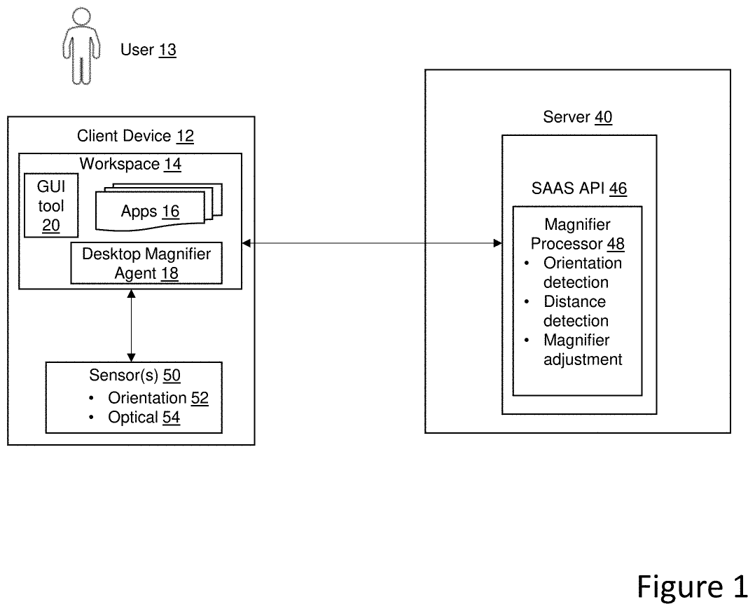

In one illustrative embodiment, the desktop magnifier platform is implemented in a virtual workspace environment, such as that shown in FIG. 1. Illustrative virtual workspace environments include CITRIX® Workspace, available from Citrix System, Inc. of Fort Lauderdale, Fla., which provides an information retrieval service where users can access programs and files from a variety of sources through a central application or a Web browser. In the example shown, a client device 12 includes a virtual workspace 14, which interacts with a server 40 such as a cloud server. Workspace 14 includes one or more applications (Apps) 16, that provide virtual desktop capabilities, i.e., the ability to create, edit and save text files, presentation files, data sorting and/or manipulation files, collaborative functions, messaging and/or electronic mail with other users of the workspace platform, social media functions, etc. In various implementations, the workspace 14 enables the client device 12 to access a virtual desktop session to run on the server 40, functions of which are further described herein. In particular cases, the display size on the client device 12 is below a threshold size, e.g., less than approximately 30 centimeters (cm), 25 cm, 20 cm, 15 cm or 10 cm in corner-to-corner distance. For example, the client device 12 can include a tablet device with a display size that is less than approximately 25 cm, or a smart phone with a display size that is less than approximately 15 cm.

In the depicted embodiment, workspace 14 is equipped with: (1) a desktop magnifier agent 18 that is used to determine an orientation of the client device 12 and/or a distance between the client device 12 and a device user 13; and (2) a graphical user interface (GUI) tool 20 that is utilized by the user 13 to view and interact with apps 16 in the workspace 14. Server 40 is responsible for managing the workspace 14 and further includes: a software as a service (SAAS) application programming interface (API) 46 that adjusts a magnifier in the workspace interface based on a determined orientation of the client device 12 and/or a distance between the client device 12 and user 13. In various implementations, the SAAS API 46 includes a magnifier processor 48 for managing the magnifier at the workspace displayed on the client's GUI tool 20. For example, the magnifier processor 48 can initiate the magnifier, e.g., in response to an interface command from the user 13, and adjust the magnifier based on a detected orientation of the client device 12 and/or distance between the user 13 and the client device 12.

As illustrated in FIG. 1, the client device 12 can further include one or more sensors 50, which in some cases include an orientation sensor 52 and/or an optical (or, vision, or time-of-flight) sensor 54 that can communicate data to the workspace 14 for aid in controlling the desktop magnifier agent 18. In certain examples, the sensors 50 are located onboard the client device 12, e.g., within or otherwise coupled with a housing of the client device 12. In some implementations, the sensors 50 are located in distinct sections of the client device 12. In particular cases, the orientation sensor 52 includes at least one of: a gyroscope, a magnetometer or an inertial measurement unit (IMU). According to various implementations, the optical sensor 54 includes at least one of a camera or a laser-based sensor.

In additional implementations, one or more of the sensors 50 (and/or additional sensors 50) is located at another connected device, e.g., an additional client device that is proximate to the user 13 (not shown). In these cases, for example, a second client device similar to client device 12 can include sensor(s) 50 for detecting a change in the orientation of the client device 12 and/or the distance between the client device 12 and the user 13. For example, a client device 12 can include a smart phone or tablet device, and the additional client device that includes the sensor(s) 50 includes a camera, an additional smart phone or tablet device, a laptop computing device, a smart speaker, entertainment system, etc.

It is understood that the distance of interest in certain magnifier adjustment calculations is the distance between the user 13 (e.g., the user's face and/or eye region) and the screen or other display (e.g., GUI) on the client device 12. On devices of small scale, e.g., smart phones and tablets, the measured distance between a front (e.g., display portion) of the client device 12 and another portion of the device 12 may be minimal, however, various implementations aim to measure or otherwise estimate the distance, roughly, between the eyes of the user 13 and the screen, interface, or display of the client device 12. Various approaches account for a measurement error in these measurements, which may range up to several percent.

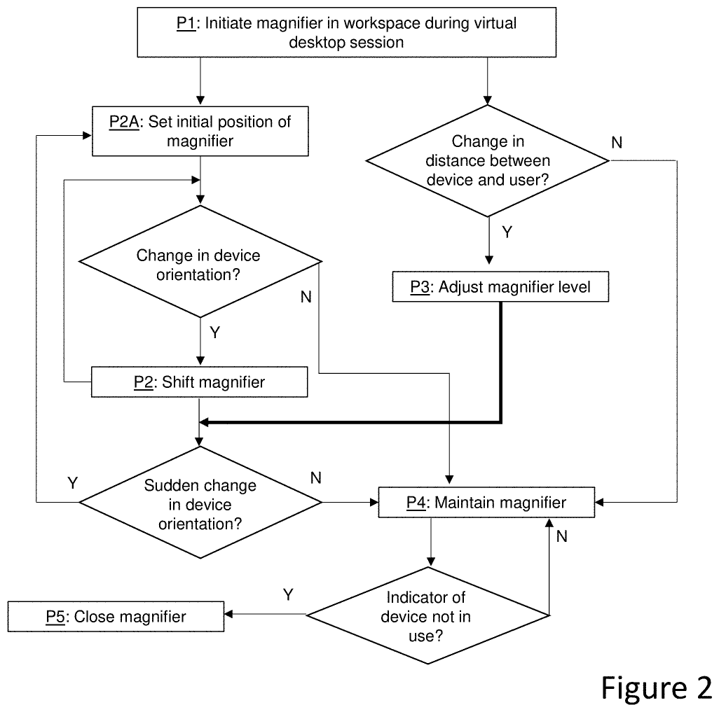

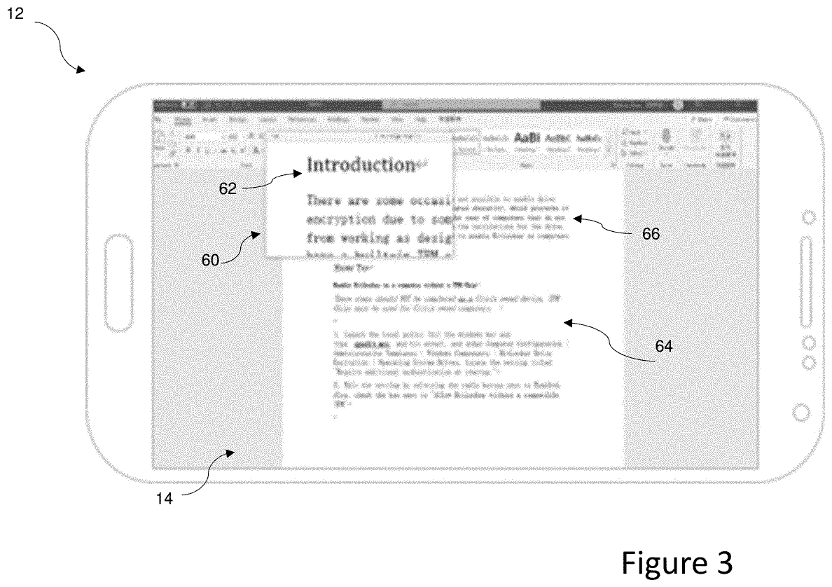

FIG. 2 is a flow diagram illustrating processes in controlling a magnifier in a virtual desktop session according to various implementations. FIGS. 3-7 illustrate the processes in the flow diagram of FIG. 2 in example virtual desktop sessions in workspace 14. With reference to FIGS. 2-7, in process P1, a magnifier 60 is initiated in the workspace 14 during a virtual desktop session to magnify a portion 62 of content 64 displayed on the client device 12. In this example, the content 64 includes a text document, and the client device 12 includes a smart phone or tablet device. As is evident from the depiction in FIG. 3, font size of the content 64 without the magnifier 60 is difficult to read, and can limit the user's 13 interaction with the workspace 14. In various implementations, the magnifier 60 is initiated in response to receiving a user command (e.g., from user 13) to initiate the magnifier 60 while the workspace 14 session is active on the client device 12. In particular implementations, the magnifier 60 is only initiated in response to receiving a user command while the workspace 14 session is active on the client device 12. Example user commands can include user interface-based commands such as tactile commands, voice commands, gesture-based commands, etc.

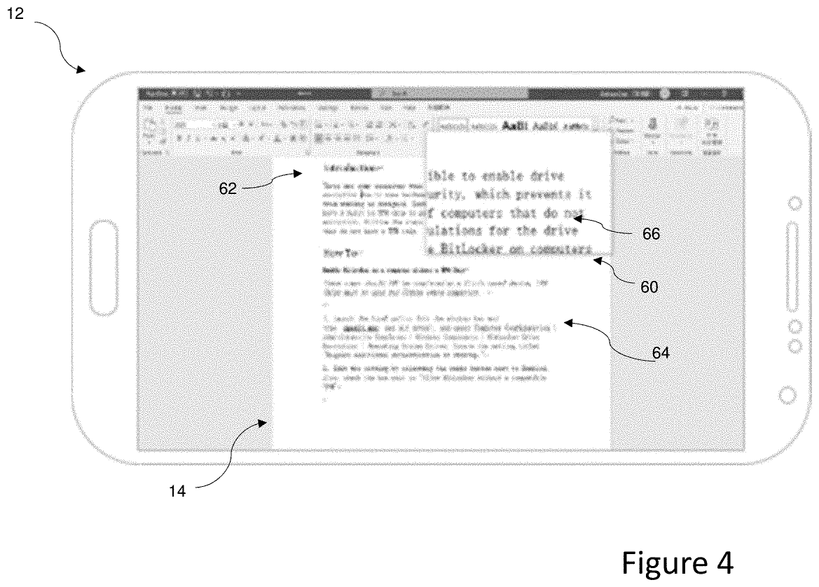

With continuing reference to FIGS. 2 and 3, in certain cases, the user 13 may wish to magnify a distinct portion 66 of the content 64 in the workspace 14. In these cases, in process P2, the workspace 14 is configured to shift the magnifier 60 to magnify the distinct portion 66 of the content 64 displayed on the client device 12 in response to detecting a change in the orientation of the client device 12. As described herein, the change in orientation can be indicated by data received from orientation sensor(s) 52. FIG. 4 illustrates process P2, including shifting the magnifier 60 in response to detecting a change in the orientation of client device 12. In this example, the sensor(s) 52 detect that the client device 12 is rotated such that the right-hand side of the device 12 is pulled closer to the user, and in response to detecting this change in orientation, the processor shifts the magnifier 60 to magnify the portion 66 of the content 64. This shift is performed without receiving a user interface command to adjust the magnifier 60, e.g., without requiring the user 13 to slide the magnifier 60, touch the screen in which the workspace 14 is displayed, make a voice command, etc. In certain of these cases, the magnifier 60 moves in a “hands-free” manner such that distinct portions of the content 64 can be magnified simply by changing the orientation of the device 12.

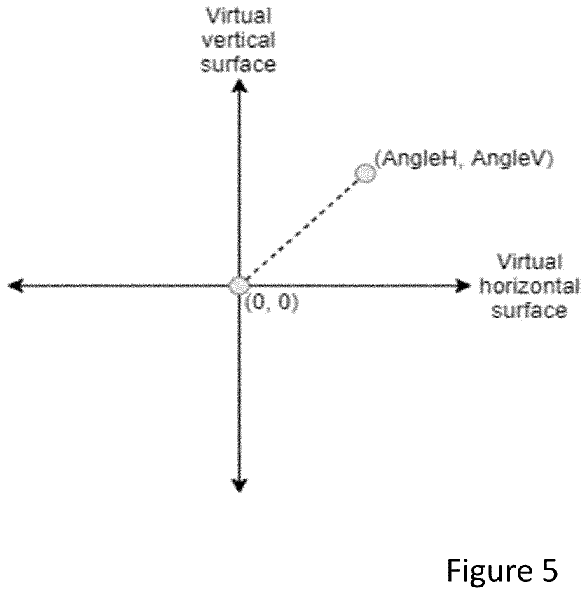

In particular implementations, in response to initiating the magnifier 60 (process P1) and prior to detecting the change in orientation of the client device 12 (process P2), the processor is configured in process P2A to set an initial position of the magnifier 60 as a 2-tuple having values of (0,0). This initial position (0,0) can also be referred to as virtual horizontal, virtual vertical. An example of a 2-tuple with an initial value of (0,0) is illustrated in the X-Y graph in FIG. 5. In these implementations, the processor is configured to detect an orientation change of the client device 12 as a change in at least one value in the 2-tuple orientation, e.g., one of the (0,0) values in the initial set. In certain of these cases, shifting the magnifier 60 (process P2) is based on a difference between the 2-tuple value of the initial position (0,0) and the 2-tuple value of the change in the orientation. In the example depiction in FIG. 5, the magnifier 60 will be shifted by a difference between the (0,0) values and the (AngleH, AngleV) values.

In various implementations, the processor is configured to revert the magnifier 60 back to the initial position (i.e., 2-tuple with (0,0) values) in response to detecting a sudden change in the orientation of the client device 12 toward at least one of the (0,0) values. As such, the user 13 can reset the magnifier 60 to the initial position with a fast (e.g., fractions of a second or less) change in device orientation toward the orientation of the device 12 when the magnifier was initiated 60, e.g., an upward facing orientation, or approximately directly facing orientation relative to the user 13. In certain cases, the sudden change in orientation is defined as an orientation change that satisfies a threshold (e.g., X degrees in either 2-tuple value) within a threshold period (e.g., one second or less, or half-a-second or less). This process is illustrated in the loop back to process P2A in FIG. 2.

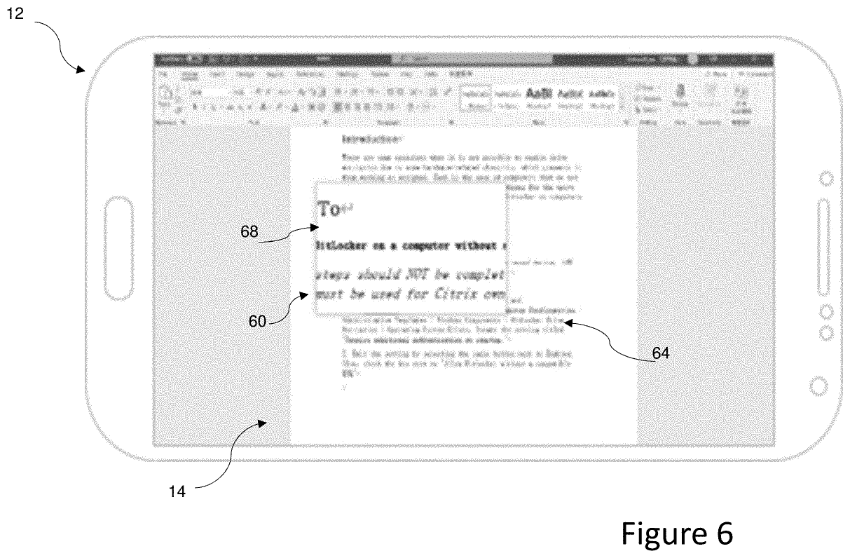

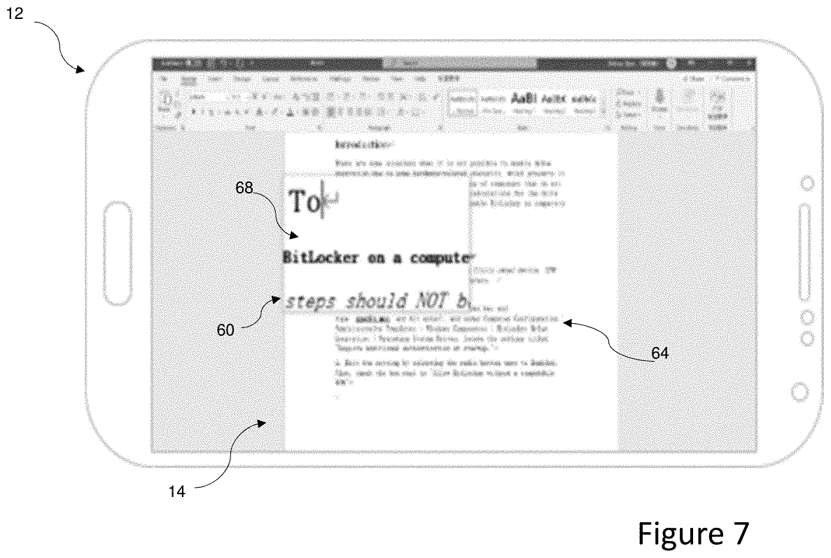

Returning to FIG. 2, and now with reference to the example depiction of workspace 14 in Figures. 6 and 7, magnifier 60 is shown magnifying a portion 68 of content 64. In this example, the magnification level of the content 64 may be undesirable to the user 13, e.g., it may be over or under magnified such that it is difficult to read significant portions of the content 64 without moving the magnifier 60, or the magnified portion of the content may still be difficult to read due to lack of magnification. In these cases, in process P3, the processor adjusts the magnification level (e.g., zoom level) of the magnifier 60 on the portion 68 of the content 64 in response to detecting a change in a distance between the client device 12 and the user 13. For example, if the user 13 has trouble viewing the portion 68 of the content 64 in the magnifier 60 because the magnification level is too low (e.g., text appears too small to be legible), the user 13 is likely to move the client device 12 closer to her eyes and/or face. If the user 13 has trouble viewing the portion 68 of the content 64 in the magnifier 60 because the magnification level is too high (e.g., text is blurred or it is difficult to view significant portions of the text without moving magnifier 60), the user 13 is likely to move the client device 12 farther from his eyes and/or face. In various implementations, as noted herein, the processor detects the change in the distance between the client device 12 and the user 13 based on data from the optical sensor 54, which can be located onboard the client device 12 and/or at a separate, connected device that is proximate to the user 13 (e.g., capable of optically detecting the distance between the user 13 and the client device 12). As with the process of shifting the magnifier 60 (process P2), the magnification level change in process P3 is performed without receiving a user interface command to adjust the magnifier 60, e.g., without requiring the user 13 to pinch or expand the magnifier 60, touch the screen in which the workspace 14 is displayed, make a voice command, etc. In certain of these cases, the magnifier 60 adjusts magnification level in a “hands-free” manner such that distinct portions of the content 64 and/or magnification level can be adjusted simply by changing the distance between the user 13 and the device 12.

In particular implementations, the processor is configured to limit the magnification level adjustment in process P3 in response to the detected distance between the user 13 and the client device 12 satisfying a threshold distance. For example, the threshold distance can include a distance range with an upper bound and a lower bound, e.g., approximately X centimeters to approximately X+Y centimeters. In some implementations, the threshold distance(s) are modifiable. For example, a user can modify the threshold distance(s) via a user interface command at GUI tool 20 (FIG. 1), or in user-defined settings for the workspace 14 and/or the magnifier 60. In additional examples, the threshold distance(s) can be adjusted by a machine learning component connected with the magnifier processor 48 (FIG. 1) that detects magnifier adjustments for one or more users over time, and adjusts threshold distances based on the historical magnifier adjustments from the user(s). In particular cases, the processor is configured to limit the magnification level adjustment by performing at least one of: a) locking the magnification level at a maximum magnification (e.g., 200%, 300%, 350%, or 400%) in response to detecting that the distance between the user 13 and the client device 12 satisfies the lower bound, or b) locking the magnification level at a minimum magnification (e.g., 100%) in response to detecting that the distance between the user 13 and the client device 12 satisfies the upper bound. An example, non-limiting magnification level equation is illustrated below, where mt represents a magnification level (or, magnification times), and d represents the distance between the user 13 and the client device 12:

$$mt = \{ \begin{matrix}0 & d < 10 cm \\ \frac{1}{20} d - \frac{1}{2} & 10 cm \leq d < 80 cm \\ 3.5 & d \geq 80 cm\end{matrix} \qquad ( Equation 1 )$$

In the example values in Equation 1, where the distance between the user 13 and client device 12 is less than 10 centimeters (cm), the magnifier 60 is maintained at a magnification value of zero times, that is, the content is presented without magnification (also referred to as 100% magnification). Between approximately 10 cm and 80 cm, the magnification level is equal to (1/20d)−(½). For distances equal to or greater than 80 cm, the magnification level is maximized at 3.5 times magnification (or, 350%). Equation 1 is but one example illustrating the bounds of magnification level that can be defined by the system and/or user(s) according to various implementations.

In various implementations, the magnifier 60 is maintained at a magnification level after adjustment until another indicator of magnification adjustment is detected (Process P4).

As illustrated in FIG. 2, in particular cases, orientation-based action (process P2) and distance-based action (process P3) for the magnifier 60 can be performed concurrently, or in any technically feasible order. In certain cases, the processor performs a magnifier adjustment in accordance with a first detected change in either orientation of the client device 12 or distance between the user 13 and client device 12. In particular cases, in response to detecting a change in both the orientation of the client device 12 and the distance between the client device 12 and the user 13, an approach can include both shifting the magnifier 60 to magnify the distinct portion of the content displayed on the client device 12 (process P2) and adjusting the magnification level of the magnifier 60 on the distinct portion of the content (process P3).

In particular cases, as shown in FIG. 2, in response to detecting an indicator that the client device 12 is not in use, the processor is configured to close the magnifier 60 (process P5), e.g., in order to conserve power on the client device 12 and/or to enhance privacy controls on the client device 12. For example, in response to detecting a change in orientation of the client device 12 and/or a distance between the client device 12 and the user 13 that indicates the client device 12 is not in use, the processor closes the magnifier 60 function in the workspace 14. For example, where the orientation of the device 12 indicates that the device is facing downward (e.g., the screen or interface is resting against a surface), and/or where the distance between the user 13 and the device 12 is detected as too far to realistically read content on the workspace 14 (e.g., approximately a meter or so apart) for a threshold period (e.g., ten seconds or more), the processor closes the magnifier 60.

In additional implementations, the processor is configured to fix, or “lock” the magnifier 60 at a magnification level in response to a trigger. For example, an interface (e.g., GUI tool 20) can be configured to receive a user command (such as any user/interface command described herein) to lock the magnification level of the magnifier 60. In a particular example, the user 13 can lock the magnification level with a voice command (e.g., “Assistant: lock magnifier”), a gesture-based command (e.g., a static hold of the device position for an extended period such as a few seconds), and/or an interface button. In certain of these cases, an “unlock” command can be enabled via the interface (e.g., GUI tool 20) to allow the user 13 to remove the lock on the magnification level. In particular examples, the “unlock” command can be similar to the revert command described herein.

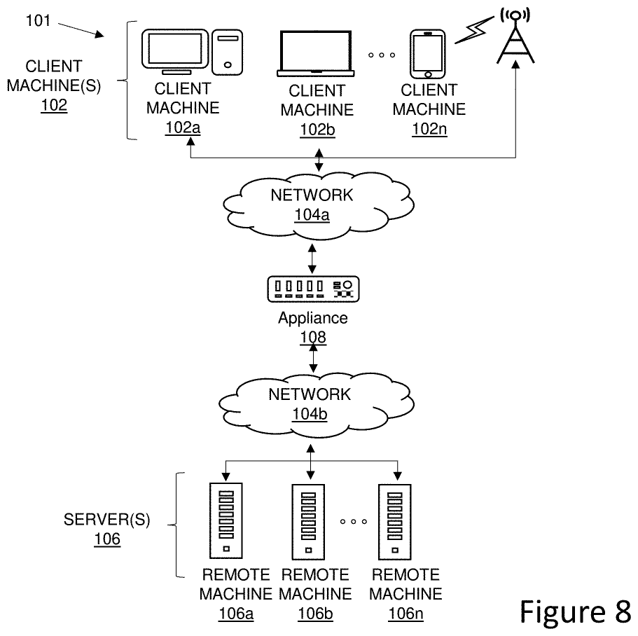

Referring to FIG. 8, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

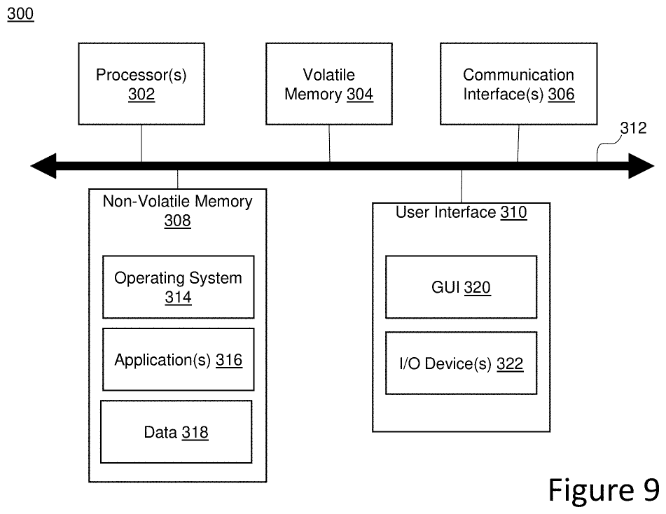

Elements of the described solution may be embodied in a computing system, such as that shown in FIG. 9 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 9 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

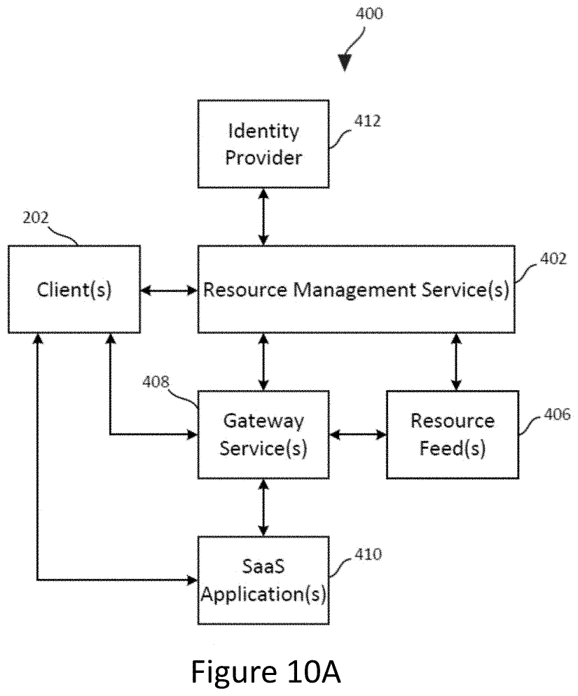

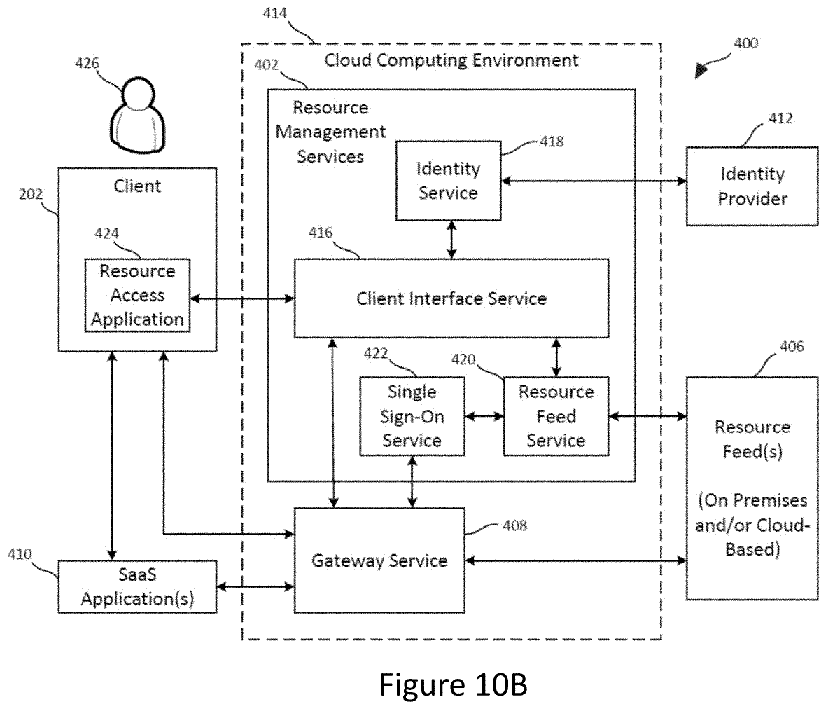

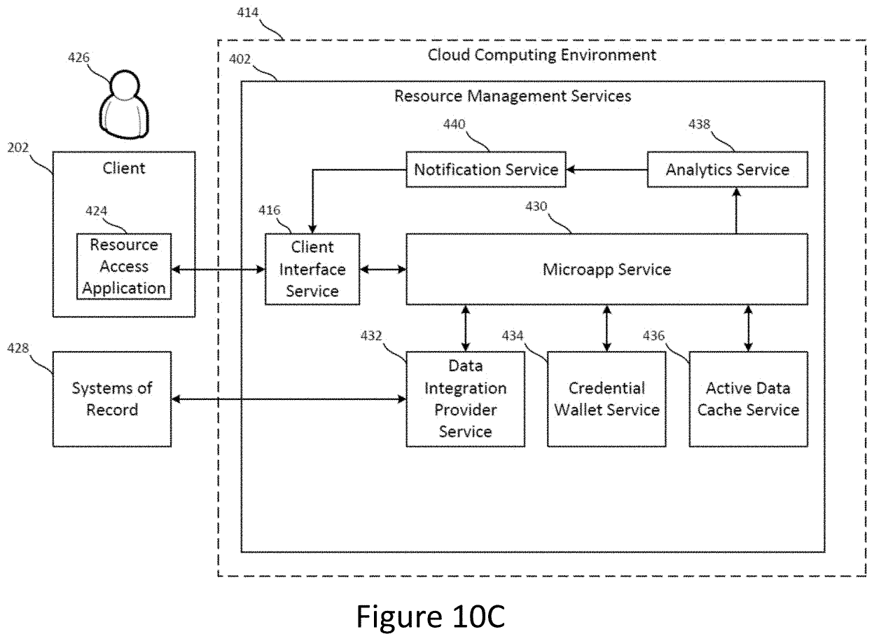

FIG. 10A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 10B is a block diagram showing an example implementation of the system 400 shown in FIG. 10A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 10B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 10B) on the client 202.

As explained in more detail below, in some embodiments, the resource access application 424 and associated components may provide the user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 10B), as described above. Upon receiving a sign-on request, the identity service 418 may cause the resource access application 424 (via the client interface service 416) to prompt the user 426 for the user's authentication credentials (e.g., user-name and password). Upon receiving the user's authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user's identity has been properly authenticated, the client interface service 416 may send a request to the resource feed service 420 for a list of subscribed resources for the user 426.

In other embodiments (not illustrated in FIG. 10B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user's authentication credentials. Upon determining the user's identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user's identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®), one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user's attention (e.g., approval of an expense report, new course available for registration, etc.).

FIG. 10C is a block diagram similar to that shown in FIG. 8B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 10C may enable the provision of a streamlined resource activity feed and/or notification process for a client 202. In the example shown, in addition to the client interface service 416 discussed above, the illustrated services include a microapp service (or simply “microservice”) 430, a data integration provider service 432, a credential wallet service 434, an active data cache service 436, an analytics service 438, and a notification service 440. In various embodiments, the services shown in FIG. 10C may be employed either in addition to or instead of the different services shown in FIG. 10B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 10C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 10C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user's actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oath2 token. The data integration provider service 432 may then decrypt the Oath2 token and write the action to the appropriate system of record under the identity of the user 426. The data integration provider service 432 may then read back changed data from the written-to system of record and send that changed data to the microapp service 430. The microapp service 432 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information they're looking for.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A computing device, comprising:
a memory storing instructions for controlling a magnifier in a virtual desktop session; and
a processor coupled to the memory and configured to execute the instructions to perform processes including:
initiating the magnifier in the virtual desktop session to magnify a portion of content displayed on a client device, wherein the magnifier is initiated in response to receiving a user initiation command while the virtual desktop session is active on the client device; and
in response to detecting a change in at least one of an orientation of the client device or a distance between the client device and a user:
adjusting a magnification level of the magnifier on the portion of the content or shifting the magnifier to magnify a distinct portion of the content displayed on the client device.

2. The computing device of claim 1, wherein the processor is further configured to:
detect the change in the orientation of the client device based on data from an orientation sensor onboard the client device.

3. The computing device of claim 2, wherein the orientation sensor comprises at least one of: a gyroscope, a magnetometer or an inertial measurement unit (IMU).

4. The computing device of claim 1, wherein the processor is further configured to:
detect the change in the distance between the client device and the user based on data from an optical sensor onboard the client device or onboard a connected device proximate to the user.

5. The computing device of claim 4, wherein the optical sensor comprises at least one of a camera or a laser-based sensor.

6. (canceled)

7. The computing device of claim 1, wherein adjusting the magnification level of the magnifier or shifting the magnifier is performed without receiving a user interface command to adjust the magnifier.

8. The computing device of claim 1, wherein the processor is configured to:
in response to detecting a change in both the orientation of the client device and the distance between the client device and the user: shifting the magnifier to magnify the distinct portion of the content displayed on the client device and adjusting the magnification level of the magnifier on the distinct portion of the content.

9. The computing device of claim 1, wherein in response to initiating the magnifier based on the user initiation command and prior to detecting the change in orientation of the client device, the processor is configured to set an initial position of the magnifier as a 2-tuple having values of (0,0), and wherein the change in the orientation of the client device is defined as a change in at least one value in the 2-tuple orientation, and wherein shifting the magnifier is based on a difference between the 2-tuple value of the initial position and the 2-tuple value of the change in the orientation,
wherein the processor is further configured to revert the magnifier back to the initial position in response to detecting a sudden change in the orientation of the client device toward at least one of the (0,0) values, wherein the sudden change in the orientation is defined as an orientation change that satisfies a threshold number of degrees in at least one 2-tuple value (0,0) within a threshold period.

10. (canceled)

11. The computing device of claim 1, wherein the processor is configured to limit the magnification level adjustment in response to the detected distance between the user and the client device satisfying a threshold distance,
wherein the threshold distance is modifiable.

12. The computing device of claim 11, wherein the threshold distance comprises a distance range with an upper bound and a lower bound, wherein limiting the magnification level adjustment comprises at least one of:
locking the magnification level at a maximum magnification in response to detecting that the distance between the user and the client device satisfies the lower bound, or
locking the magnification level at a minimum magnification in response to detecting that the distance between the user and the client device satisfies the upper bound.

13. (canceled)

14. The computing device of claim 1, wherein the processor is configured to close the magnifier in response to detecting at least one of an orientation of the client device or a distance between the user and the client device that indicates the client device is not in use.

15. The computing device of claim 1, wherein the client device comprises a mobile device including at least one of a smart phone or a tablet computing device.

16. A method of controlling a magnifier in a virtual desktop session, the method comprising:
initiating the magnifier in the virtual desktop session to magnify a portion of content displayed on a client device, wherein the magnifier is initiated in response to receiving a user initiation command while the virtual desktop session is active on the client device; and
in response to detecting a change in at least one of an orientation of the client device or a distance between the client device and a user:
adjusting a magnification level of the magnifier on the portion of the content, or shifting the magnifier to magnify a distinct portion of the content displayed on the client device.

17. The method of claim 16, further comprising:
detecting the change in the orientation of the client device based on data from an orientation sensor onboard the client device, or
detecting the change in the distance between the client device and the user based on data from an optical sensor onboard the client device or onboard a connected device proximate to the user.

18. (canceled)

19. A non-transitory computer readable storage medium having program code, which when executed by a computing device, causes the computing device to control a magnifier in a virtual desktop session by performing actions comprising:
initiating the magnifier in the virtual desktop session to magnify a portion of content displayed on a client device, wherein the magnifier is initiated in response to receiving a user initiation command while the virtual desktop session is active on the client device; and
in response to detecting a change in at least one of an orientation of the client device or a distance between the client device and a user:
adjusting a magnification level of the magnifier on the portion of the content, or shifting the magnifier to magnify a distinct portion of the content displayed on the client device.

20. The computer readable medium of claim 19, wherein the virtual desktop session includes a workspace session, wherein initiating the magnifier is only performed in response to receiving a user command to initiate the magnifier while the virtual desktop session is active on the client device, and wherein adjusting the magnification level of the magnifier or shifting the magnifier is performed without receiving a user interface command to adjust the magnifier.

21. The computing device of claim 1, wherein the virtual desktop session includes a workspace session, and wherein the magnifier is only initiated in response to receiving the user initiation command while the workspace session is active on the computing device.

22. The computing device of claim 11, wherein the processor uses a machine learning component to adjust the threshold distance based on historical magnifier adjustments from one or more users over time.

23. The computing device of claim 12, wherein limiting the magnification level adjustment is further defined by a magnification level (mt) equation:
$$mt = \{ \begin{matrix}0 & d < 10 cm \\ \frac{1}{20} d - \frac{1}{2} & 10 cm \leq d < 80 cm \\ 3.5 & d \geq 80 cm\end{matrix}$$
wherein d is a distance between the user and a display on the client device.

24. The method of claim 16, wherein the virtual desktop session includes a workspace session, and wherein the magnifier is only initiated in response to receiving the user initiation command while the workspace session is active on the computing device.
